(19) United States
(12) Patent Application Publication
(10) Pub. No.: US 2012/0171542 A1
(43) Pub. Date: Jul. 5, 2012

(54) SECONDARY BATTERY

(75) Inventors: Kazuaki Matsumoto, Tokyo (JP); Kentaro Nakahara, Tokyo (JP); Kaichiro Nakano, Tokyo (JP)

(73) Assignee: NEC Corporation, Minato-ku ,Tokyo (JP)

(21) Appl. No.: 13/394,676

(22) PCT Filed: Aug. 30, 2010
(86) PCT No.: PCT/JP2010/064699

§ 371 Date: Mar. 7, 2012

(30) Foreign Application Priority Data
Sep. 9, 2009 (JP) 2009-208171

(51) Int. Cl. H01M 4/48; H01M 4/52; H01M 10/02; H01M 4/505

(52) U.S. Cl. 429/107; 429/105

(57) ABSTRACT

A secondary battery including: a positive electrode which comprises an oxide which absorbs and releases lithium ions; a negative electrode which comprises a material which absorbs and releases the lithium ions; and a first electrolyte solution which transports charge carriers between the positive electrode and the negative electrode; wherein the positive electrode comprises a compound, which is represented by the composition formula LiₐM¹_{b}O_{d} or LiₐM¹_{b}M²_{c}O_{d}, and the positive electrode is formed by electrically combining lithium metal and a lithium-containing transition metal oxide in a second electrolyte solution which includes lithium ions. In the formulae, a, b, c and d represent a composition ratio of the above composition formulae, and are numbers in ranges of: 1.2≦a≦2, 0<b, c≦2, and 2≦d≦4, M¹ and M² in the above formulae represent any one kind of elements selected from the group consisting of Co, Ni, Mn, Fe, Al, Sn, Mg, Ge, Si and P, and M¹ and M² are different from each other.

### TECHNICAL FIELD

The present invention relates to a secondary battery. Priority is claimed on Japanese Patent Application No. 2009-208171, filed on Sep. 9, 2009, the content of which is incorporated herein by reference.

### BACKGROUND ART

As a secondary battery which can be repeatedly charged/discharged, a lithium secondary battery which has a high energy density has been mainly used. This type of secondary battery includes a positive electrode, a negative electrode, and an electrolyte (electrolysis solution) as constituent elements. In general, as the positive active material, a lithium-containing transition metal oxide is used. As the negative active material, lithium metal, a lithium alloy, a carbon material that absorbs and desorbs lithium ions, a silicon material, a tin material, or the like, are used. As an electrolyte, an organic solvent is used in which a lithium salt such as lithium borate tetrafluoride (LiBF₄), lithium phosphate hexafluoride (LiPF₆), or the like has been dissolved. As the organic solvent, an aprotic organic solvent such as ethylene carbonate or propylene carbonate is used. As the positive active material, materials such as LiCoO₂ and LiNiO₂, which have high theoretical capacity, LiCO_{0.15}Ni_{0.8}Al_{0.05}O₂, which has a high output, LiMn₂O₂, LiMnPO₄ and LiFePO₄, which have high safety, and the like have been particularly studied. In a lithium ion secondary battery, wherein lithium-manganese oxide is used as a positive electrode and graphite is used as a negative electrode, it is known that charge-discharge curves of the battery with respect to the lithium ratio have a plateau region (a potential flat area) in the voltage of 3.8 to 4.1 V. The above thing originates from the reaction of LiMn₂O₄→Li₁₋ₓMn₂O₄+xe⁻+xLi⁺.

Recently, technical developments of a lithium ion secondary battery have been performed for a vehicle and a large storage equipment actively, and characteristics of the battery which satisfy all of high capacity, high output and high safety have been requested. Accordingly, various studies have been performed for a positive electrode, a negative electrode and an electrolyte of a lithium ion secondary battery to improve them, and there is a technique wherein the lithium content in a positive electrode is increased to improve a positive electrode. For example, a chemical reaction wherein theoretical capacity of a positive electrode is increased is used in Non-Patent Document 1. As said chemical reaction, a reaction shown by LiMn₂O₄+3x/2 LiI→Li₁₊ₓMn₂O₄+x/2 LiI₃ is cited.

However, charge-discharge curves of a lithium ion secondary battery wherein an excess lithium-positive electrode is used as described above have a plateau region at the voltage of 2.8 to 3.0 V with respect to the lithium ratio. It was reported that this phenomenon originates from the reaction shown by LiMn₂O₄+ye⁻+yLi⁺ [symbol] Li_{1+y}Mn₂O₄. Furthermore, it was reported that if charge and discharge are repeated at the voltage of 2.8 to 3.0 V, charge and discharge capacity deteriorates. (For example, refer to Non-Patent Document 1.)

It was pointed out that the above deterioration of cycle performance was caused by the volume change based on the reaction shown by LiMn₂O₄+ye⁻+yLi⁺→Li_{1+y}Mn₂O₄. Furthermore, it was reported that, when transition occurred from LiMn₂O₄ (cubic crystal) to Li_{1+y}Mn₂O₄ (tetragonal crystal), volume was change with about 6% of volume expansion. (For example, refer to Non-Patent Document 3.) In order to achieve stable cycle performance, it is necessary to merely use a reaction represented by LiMn₂O₄ [symbol] Li_{1-y}Mn₂O₄+ye⁻+yLi⁺, and therefore, the lower limit of a potential of a lithium ion secondary battery was limited to 3.0 V.

Furthermore, in Patent Document 1, lithium was carried on a positive electrode due to an electrochemical contact between a positive electrode and lithium which was arranged so as to face against the positive electrode or a negative electrode, so that the lithium content in a positive electrode material increases. However, in order to use the aforementioned positive electrode for a large capacity cell, it is preferable that all lithium included in the positive electrode be used in charge and discharge steps, and therefore a reaction shown by Li_{1+y}Mn₂O₄ [symbol] LiMn₂O₄+ye⁻+yLi⁺ which is observed at the voltage of 2.8 to 3.0 V, and a reaction shown by LiMn₂O₄ [symbol] Li_{1-y}Mn₂O₄+ye⁻+yLi⁺, which is observed at the voltage of 3.6 to 3.8 V, are necessary to be used. In the aforementioned Patent Document, evaluation of Examples was performed in the range of 2.0 to 4.2 V to generate a high capacity cell, and therefore, although cell capacity may increase, capacity deteriorates after cycles due to the aforementioned volume change. Here, in the aforementioned formulae, coefficients x and y are used so that a unit is shown based on mole.

On the other hand, there is a method wherein phosphate ester is mixed with electrolyte in order to improve the safety of a secondary battery. However, phosphate ester has poor resistance to reduction, and therefore, when phosphate ester is mixed with a carbonate-based electrolysis solution, phosphate ester is decomposed on an electrode. Although there is a method in which additives are further added to improve such a decomposition, rate performance deteriorates because resistance increases due to decomposition product generated from the additives.

Furthermore, when a positive electrode material wherein lithium is included excessively is synthesized by a conventional chemical reaction, a small amount of a reaction solvent and halide ions which have been mixed with a product remain, even if refining is performed. Halide ions have low standard oxidation-reduction potential (0.5V vs SHE), and cannot withstand voltage of a lithium ion battery. Accordingly, there is a concern that a decomposition reaction thereof occurs on an electrode and adverse effects are brought to a battery reaction. Therefore, it is desired that impurities are not included in battery materials as much as possible.

Furthermore, expectation for storage techniques increases due to the recent energy situation, and techniques which can improve cycle performance and rate performance become more and more important.

### BACKGROUND ART LITERATURE

(Patent Documents)

Patent Document 1: Japanese Patent No. 3485935

(Non-Patent Documents)

Non-Patent Document 1: J. M. Tarascon and D. Guyomard, “Li Metal-Free Rechargeable Batteries based on Li_{1+X}Mn₂O₄ Cathodes (0≦x≦1) and Carbon Anodes”, J. Electrochem. Soc. Vol. 138, pp. 2864 to 2868 (1991)

Non-Patent Document 2: Zhiping Jiang and K. M. Abraham, “Preparation and Electrochemical Characterization of Micron-Sized LiMn₂O₄” J. Electrochem. Soc. Vol. 143, pp 1591 to 1598 (1996)

Non-Patent Document 3: Hiromasa Ikuta, Yoshiharu Uchimoto, and Masataka Wakihara, “Crystal Structure Control of Lithium Manganese Spinal Oxides and Their Application to Lithium Secondary Battery”, Nippon Kagaku Kaishi, No. 3, pp 271 to 280 (2002)

### DISCLOSURE OF INVENTION

### Problems that the Invention is to Solve

The present invention was made based on the aforementioned circumstances, and the object of the present invention is to offer a secondary battery which can improve cycle performance and rate performance.

### Means for Solving the Problems

As a result of intensive studies aimed at achieving the aforementioned objects, the present inventors generated a specific secondary battery wherein a positive electrode includes a compound represented by the composition formula: LiₐM¹_{b}O_{d} or LiₐM¹_{b}M²_{c}O_{d}, and found that the secondary battery shows excellent effects.

The first aspect of the present invention which solves the aforementioned objects is a secondary battery shown below.

(1) That is, a secondary battery is proposed, wherein the secondary battery includes: a positive electrode which comprises an oxide which absorbs and releases lithium ions; a negative electrode which comprises a material which absorbs and releases the lithium ions; and a first electrolyte solution which transports charge carriers between the positive electrode and the negative electrode, and wherein the positive electrode comprises a compound which is represented by the composition formula: LiₐM¹_{b}O_{d} or LiₐM¹_{b}M²_{c}O_{d}, and is a positive electrode which is formed by electrically combining lithium metal and a lithium-containing transition metal oxide in a second electrolyte solution which includes lithium ions. (a, b, c and d, which represent a composition ratio of the above composition formulae, represent numbers in ranges of: 1.2≦a≦2, 0<b, c≦2, and 2≦d≦4, and M¹ and M² in the above formulae represent any one kind of an element selected from the group consisting of Co, Ni, Mn, Fe, Al, Sn, Mg, Ge, Si and P, and M¹ and M² are different from each other.)

The aforementioned secondary battery preferably has the following characteristics.

(2) The first electrolyte solution preferably comprises a carbonate organic solvent.

(3) The first electrolyte solution of (1) or (2) preferably comprises 15% by volume or more of a phosphate ester.

(4) The aforementioned secondary battery described in (1), (2) and (3) preferably includes a film-forming additive which electrochemically forms a film on the negative electrode.

(5) The aforementioned secondary battery of (1), (2) or (3) preferably comprises a film, which is impermeable to the first electrolyte solution but permeable to lithium ions, on the negative electrode thereof.

### Effects of the Invention

According to the present invention, a secondary battery which can increase cycle performance and rate performance can be proposed.

### BRIEF DESCRIPTION OF THE DRAWINGS

FIG. 1 shows a schematic view of one example of a basic structure to form a positive electrode of the secondary battery of the present invention.

FIG. 2 shows a schematic view of one example of a secondary battery of the present invention.

FIG. 3 shows an exploded view of a coin-type secondary battery.

FIG. 4 shows a view of the measurement results of XRD of a positive electrode of Examples and Comparative Examples of the present invention.

FIG. 5 shows an initial charge curve of coin cells of Examples of the present invention.

FIG. 6 shows evaluation results of rate performance of coin cells of Examples and Comparative Examples of the present invention.

### BEST MODE FOR CARRYING OUT THE INVENTION

The inventors of the present invention performed evaluations of rate performance and evaluation of cycle performance using a secondary battery which includes a positive electrode represented by the aforementioned composition formulae, and found that such an electrode can improve cycle performance and rate performance. The present inventors presume that the above improvement is caused due the use of a positive electrode (excess lithium-positive electrode) represented by the above formulae, because the amount of lithium which is stored in a negative electrode when charging is performed increases, as compared with a case when a general positive electrode is used, and discharge capacity increases.

An excess lithium-positive electrode is generated by electrically combining lithium metal and a lithium transition metal oxide in an electrolyte solution which includes a lithium ion, and therefore lithium ions selectively adhere to the surface portion of a positive electrode. As a result, with respect to the amount of lithium in the positive electrode, the amount of lithium existing at the surface position of the positive electrode becomes larger than that existing at the inner position of the positive electrode. Namely, it is presumed that, a film having comparatively large amount of lithium is formed at the surface of the positive electrode, volume change which is caused by crystal-structure change becomes hard to be caused at the positive electrode since the formed film functions as a protective film, and deterioration of cycle performance originated from volume change, which is conventionally caused, can be prevented.

According to the secondary battery which has the aforementioned composition formula, it is possible to improve cycle performance and rate performance. It is also presumed that adverse effects to a battery reaction, which are conventional concerns, can be prevented, since a decomposition reaction which is conventionally caused on the positive electrode is hard to be caused due to the protective film formed on the surface of the positive electrode, and impurity becomes hard to be generated.

Hereinafter, embodiments of the invention will be described with reference to the drawings. The embodiments are only for illustrating a certain embodiment, and are not limitative of the invention. Modification are possible without departing from the scope of technical ideas of the invention. Number, position, size, value and the like can be changed or added, without departing from the scope of the invention. In order to make each constitution of the drawings comprehensible, scale, number and the like of each structure of the drawings and actual structures differ from one another.

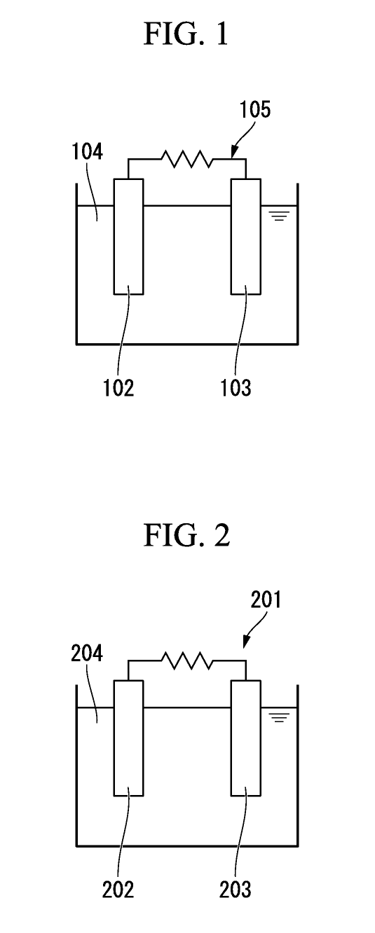

FIG. 1 is a schematic view which shows a basic structure for forming a positive electrode (excess lithium-positive electrode) according to a secondary battery of the present invention. As shown in FIG. 1, the basic structure which is used for forming an excess lithium-positive electrode includes: a lithium transition metal oxide electrode (lithium-containing transition metal oxide) 102; a lithium electrode (lithium metal) 103; a second electrolyte solution which includes lithium ions (second electrolyte) 104; and an electrically conductive material 105. As the electrically conductive material 105, for example, a copper wire and an aluminum bar can be cited, but any material can be used in so far as said material is an electrical conductive material. Furthermore, the form and the size of the electrodes can be selected optionally. Although concentration of lithium salt can be selected optionally, 0.1 to 3 is preferable, and 0.8 to 2 is more preferable.

FIG. 2 is a schematic view which shows a secondary battery 201 of the present invention. As shown in FIG. 2, the secondary battery 201 is structured to include a positive electrode 2020, a negative electrode 203 and an electrolyte solution (first electrolyte solution) 204. The positive electrode 202 is an excess lithium-positive electrode which is generated according to the aforementioned basic structure, a manufacturing method of a positive electrode described below or the like, and is formed so that the positive electrode includes an oxide which adsorbs and releases lithium ions. The negative electrode 203 is formed so that the negative electrode includes a material which adsorbs and releases lithium ions. The electrolyte solution 204 is a liquid which transports charge carriers (ion, electron, or electron hole) between the positive electrode and the negative electrode, and is structured such that the solution includes a lithium salt. Here, the electrolyte 204 may be structured so that the electrolyte includes both a phosphorus compound and a high-concentration lithium salt. The concentration of lithium salt is optionally selected, and is preferably 0.1 to 3 and more preferably 0.8 to 2.

The positive electrode 202 includes a compound represented by the composition formula: LiₐM¹_{b}O_{d} or LiₐM¹_{b}M²_{c}O_{d}. (a, b, c and d represent numbers in ranges of: 1.2≦a≦2, 0<b, c≦2, and 2≦d≦4, and M¹ and M² in the formulae represent any one kind of an element selected from the group consisting of Co, Ni, Mn, Fe, Al, Sn, Mg, Ge, Si and P, and M¹ and M² are not identical.)

In the formulae, a is preferably a number of 1.2≦a≦1.7. It is preferable that M¹ and M² be selected from Mn, Ni, Co, Fe, P, Mg, Si, Sn and Al, and more preferably selected from Mn, Ni, Co, Al, P and Fe. Concrete examples of a compound represented by the composition formula: LiₐM¹_{b}O_{d} or LiₐM¹_{b}M²_{c}O_{d}, preferably include Li_{1.3}Mn₂O₄, Li_{1.2}CoO₂, Li_{1.2}NiO₂, Li_{1.3}Co_{0.15}Ni_{0.8}Al_{0.05}O₂, Li_{1.3}Mn_{1.5}Ni_{0.5}O₄ and the like. However, the compound is not limited these compounds.

Furthermore, the positive electrode 202 may have a form wherein a positive electrode is formed on a positive electrode collector. States and conditions for forming thereof can be optionally selected. As forming materials of the collector, for example, nickel, aluminum, copper, gold, silver, an aluminum alloy and stainless steel can be cited. Furthermore, as the positive electrode collector, foil made of carbon or the like, a metal plate or the like can be used.

A material used for forming a negative electrode 203 can be optionally selected in so far as it includes a material which adsorbs and releases lithium ions. For example, conventionally used carbon materials, silicon materials, nickel materials, lithium metals can be cited. Concrete examples of the carbon materials include: pyrolytic carbons, cokes (pitch cokes, needle cokes, petroleum cokes and the like), graphites, glassy carbons, organic polymer compound sintered bodies (carbonated materials obtained by sintering phenol resins, furan resins or the like at an appropriate temperature), carbon fibers, activated carbons, and graphites. In the present invention, cokes, activated carbons, graphite and the like are still more preferably used.

Furthermore, the negative electrode 203 may be formed from plural structural materials, and in such a case, a binding agent may be used for enhancing the bonding between the structural materials of the negative electrode 203. Examples of the binder agent include: polytetrafluoroethylene, polyvinylidene fluoride, vinylidene fluoride-hexafluoropropylene copolymer, vinylidene fluoride-tetrafluoroethylene copolymer, styrene-butadiene copolymer rubber, polypropylene, polyethylene, polyimide, partially carboxylated cellulose, various polyurethanes and polyacrylonitrile.

The negative electrode 203 may have a structure wherein a positive electrode is formed on a negative electrode collector. Formed state and the like can be selected optionally. As a forming material of the collector, for example, nickel, aluminum, copper, gold, silver, an aluminum alloy and stainless steel can be cited similar to the aforementioned forming material of the positive electrode collector. Furthermore, as the negative electrode collector, foil made of carbon or the like, a metal plate or the like can be used.

On the surface of the negative electrode 203, SEI (solid electrolyte interphase) may be formed in advance. Since SEI functions as a protective film, reductive decomposition between a negative electrode 203 and an electrolyte solution 204 can be inhibited. Furthermore, a reaction can be occurred reversibly and smoothly at the negative electrode 203. Accordingly, capacity degradation of the secondary battery 201 can be prevented. Here, SEI is a film which is impermeable to an electrolyte solution 204 but permeable to lithium ions. SEI may be produced in advance on a negative electrode in the process where a lithium ion battery is formed, and is charged and discharged.

Although SEI can be formed by vapor deposition, chemical decoration or the like, it is preferable that SEI be formed electrochemically. Concrete examples of the electrochemical formation include a method of forming SEI, wherein a battery including an electrode, which is made of a carbon material, and another electrode, which exists as a counter electrode via a separator and is made of a material which discharges lithium ions, is generated, and charging and discharging are repeated at least once to form SEI on the negative electrode (carbon material). After the charging and discharging are performed, the electrode made of the carbon material is taken out, and be used as a negative electrode 203 of the present invention. Here, as an electrolyte solution used in the method, a carbonate electrolyte solution including a lithium salt dissolved therein can be used. Furthermore, charging and discharging may be terminated by the discharge to obtain an electrode wherein lithium ions are inserted in the layer of a carbon material, and the electrode may be used as a negative electrode 203 of the present invention.

As a phosphorus compound which can be included in the electrolyte solution 204, for example, phosphate ester derivatives can be cited. As examples of the phosphate ester derivatives, compounds represented by the following general formulae 1 and 2 can be cited.

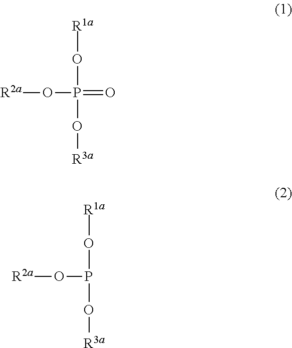

In the formulae (1) and (2), R^{1a}, R^{2a} and R^{3a} may be identical or different from each other, and represent an alkyl group having 7 or less carbon atoms, an alkyl halide group, an alkenyl group, a cyano group, a phenyl group, an amino group, a nitro group, an alkoxy group, a cycloalkyl group, or a silyl group, and may have a cyclic structure wherein any or all of R^{1a}, R^{2a} and R^{3a} are bonded with each other.

Concrete examples of the phosphorus compound include: trimethyl phosphate, triethyl phosphate, tributyl phosphate, tripentyl phosphate, dimethylethyl phosphate, dimethylpropyl phosphate, dimethylbutyl phosphate, diethylmethyl phosphate, dipropylmethyl phosphate, dibutylmethyl phosphate, methylethylpropyl phosphate, methylethylbutyl phosphate, and methylpropyllbutyl phosphate. Concrete examples of the phosphorus compound further include: trimethyl phosphite, triethyl phosphite, tributyl phosphate, triphenyl phosphite, dimethylethyl phosphite, dimethylpropyl phosphite, dimethylbutyl phosphite, diethylmethyl phosphite, dipropylmethyl phosphite, dibutylmethyl phosphite, methylethylpropyl phosphite, methylethylbutyl phosphite, methylpropylbutyl phosphite, and dimethyl-trimethyl-silyl phosphite. Trimethyl phosphate and triethyl phosphate are particularly preferable due to high safety thereof.

Furthermore, a compound represented by any of the general formulae (3), (4), (5) and (6) can be cited as examples of the phosphate ester derivative.

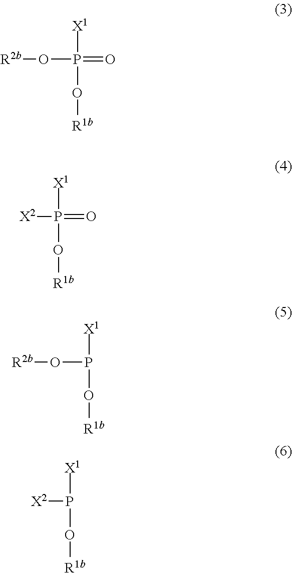

In the general formulae (3), (4), (5) and (6), R^{1b} and R^{2b} may be identical or different from each other, and represent an alkyl group having seven or less carbon atoms, an alkyl halide group, an alkenyl group, a cyano group, a phenyl group, an amino group, a nitro group, an alkoxy group or a cycloalkyl group, and may have a cyclic structure wherein R^{1b} and R^{2b} are bonded with each other. X¹ and X² are halogen atoms which may be identical or different from each other.

Specific examples of the phosphorus compound include: methyl(trifluoroethyl)fluorophosphate, ethyl(trifluoroethyl)fluorophosphate, propyl(trifluoroethyl)fluorophosphate, aryl(trifluoroethyl)fluorophosphate, butyl(trifluoroethyl)fluorophosphate, phenyl(trifluoroethyl)fluorophosphate, bis(trifluoroethyl)fluorophosphate, methyl(tetrafluoropropyl)fluorophosphate, ethyl(tetrafluoropropyl)fluorophosphate, tetrafluoropropyl(trifluoroethyl)fluorophosphate, phenyl(tetrafluoropropyl)fluorophosphate, bis(tetrafluoropropyl)fluorophosphate, methyl(fluorophenyl)fluorophosphate, ethyl(fluorophenyl)fluorophosphate, fluorophenyl(trifluoroethyl)fluorophosphate, difluorophenyl fluorophosphate, fluorophenyl(tetrafluoropropyl)fluorophosphate, methyl(difluorophenyl)fluorophosphate, ethyl(difluorophenyl)fluorophosphate, difluorophenyl(trifluoroethyl)fluorophosphate, bis(difluorophenyl)fluorophosphate, difluorophenyl(tetrafluoropropyl)fluorophosphate, fluoro ethylene fluorophosphate, difluoroethylene fluorophosphate, fluoropropylene fluorophosphate, difluoropropylene fluorophosphate, trifluoropropylene fluorophosphate, fluoroethyl difluorophosphate, difluoroethyl difluorophosphate, fluoropropyl difluorophosphate, difluoropropyl difluorophosphate, trifluoropropyl difluorophosphate, tetrafluoropropyl difluorophosphate, pentafluoropropyl difluorophosphate, fluoroisopropyl difluorophosphate, difluoroisopropyl difluorophosphate, trifluoroisopropyl difluorophosphate, tetrafluoroisopropyl difluorophosphate, pentafluoroisopropyl difluorophosphate, hexafluoroisopropyl difluorophosphate, heptafluorobutyl difluorophosphate, hexafluorobutyl difluorophosphate, octacluorobutyl difluorophosphate, perfluoro-t-butyl difluorophosphate, hexafluoroisobutyl difluorophosphate, fluorophenyl difluorophosphate, difluorophenyl difluorophosphate, 2-fluoro-4-methylphenyl difluorophosphate, trifluorophenyl difluorophosphate, tetrafluorophenyl difluorophosphate, pentafluorophenyl difluorophosphate, 2-fluoromethylphenyl difluorophosphate, 4-fluoromethylphenyl difluorophosphate, 2-difluoromethylphenyl difluorophosphate, 3-difluoromethylphenyl difluorophosphate, 4-difluoromethylphenyl difluorophosphate, 2-trifluoromethylphenyl difluorophosphate, 3-trifluoromethylphenyl difluorophosphate, 4-trifluoromethylphenyl difluorophosphate, and 2-fluoro-4-methoxyphenyl difluorophosphate. Among them, fluoroethylene fluorophosphate, bis(trifluoroethyl)fluorophosphate, fluoroethyl difluorophosphate, trifluoroethyl difluorophosphate, propyl difluorophosphate, and phenyl difluorophosphate are preferable. Fluoroethyl difluorophosphate, tetrafluoropropyl difluorophosphate and fluorophenyl difluorophosphate are particularly preferable from the viewpoints of low viscosity and fire retardancy thereof.

The aforementioned phosphate ester derivatives can be mixed with the electrolyte solution 204 to make the electrolyte solution be non-flammable. A better non-flammable effect can be obtained as the concentration of the phosphate ester derivatives is higher. In the present embodiment, it is preferable that the electrolyte solution 204 preferably include 15% by volume or more of phosphate ester, more preferably includes 20% by volume or more of phosphate ester, and still more preferably includes 25% by volume or more of phosphate ester. Although the upper limit of the amount thereof can be selected optionally, 90% by volume or less is more preferable, and 60% by volume or less is still more preferable. The phosphate ester derivatives may be used alone or in combination of two or more.

The electrolyte solution 204 may include a carbonate organic solvent. Examples of the carbonate organic solvent include: ethylene carbonate (EC), propylene carbonate (PC), butylene carbonate, dimethyl carbonate (DMC), ethylmethyl carbonate (EMC), diethyl carbonate (DEC), dimethoxyethane, diethyl ether, phenylmethyl ether, tetrahydrofuran (THF), γ-butyrolactone and γ-valerolactone. From the viewpoint of safety, ethylene carbonate, diethyl carbonate, propylene carbonate, dimethyl carbonate, etylmethyl carbonate, γ-butyrolactone and γ-valerolactone are particularly preferable, but the carbonate organic solvent usable in the invention is not limited to these solvents.

The aforementioned carbonate organic solvents can be mixed with the electrolyte solution 204 to increase capacity. The concentration of these carbonate organic solvents is preferably 5% by volume or more, and more preferably 10% by volume or more, in order to achieve the sufficient capacity improving effect. The carbonate organic solvents may be used alone or in combination of two or more.

The electrolyte solution 204 may include a film-forming additive which forms a film on the surface of the negative electrode 203 electrochemically. By the additive, reductive decomposition between a negative electrode 203 and an electrolyte solution 204 can be inhibited, since the film formed on the negative electrode 203 functions as a protective film. Furthermore, a reaction at the negative electrode 203 can be occurred reversibly and smoothly. Accordingly, capacity degradation of the secondary battery 201 can be prevented.

Examples of the film-forming additive include: vinylene carbonate (VC), vinyl etylene carbonate (VEC), ethylene sulfite (ES), propane sultone (PS), butane sultone (BS), sulfolene, sulfolane, dioxathiolane-2,2-dioxide, pentanedione, fluoro ethylene carbonate (FEC), chloro ethylene carbonate (CEC), succinic anhydride (SUCAH), propionic anhydride, diaryl carbonate (DAC), and diphenyl disulfide (DPS), but the film additive usable in the invention is not limited to the additives. If the additive amount is too much, it will adversely affect the battery characteristics, and therefore, the amount thereof is preferably less than 10% by mass. VC, VEC and PS are particularly preferable as the film-forming additive. The film-forming additives may be used either alone or in combination of two or more.

Furthermore, as the electrolyte solution 204, an organic solvent having a lithium salt dissolved therein can be used. The lithium salt can be optionally selected, and examples thereof include: LiPF₆, LiBF₄, LiAsF₆, LiClO₄, Li₂B₁₀C₁₁₀, Li₂B₁₂C₁₁₂, LiB(C₂O₄)₂, LiCF₃SO₃, LiCl, LiBr, and LiI. Furthermore, examples thereof also include: LiBF₃(CF₃), LiBF₃(C₂F₅), LiBF₃(C₃F₇), LiBF₂(CF₃)₂, and LiBF₂(CF₃)(C₂F₅) obtained by substituting at least one fluorine atom in LiBF₄ with an alkyl fluoride group, and LiPF₅(CF₃), LiPF₅(C₂F₅), LiPF₅(C₃F₇), LiPF₄(CF₃)₂, LiPF₄(CF₃)(C₂F₅), and LiPF₃(CF₃)₃ obtained by substituting at least one fluorine atom in LiPF₆ with an alkyl fluoride group.

In addition, as the lithium salt, a compound represented by the general formula (7) can be cited.

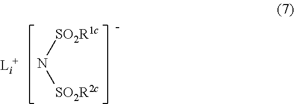

Here, R^{1c} and R^{2c} in the general formula (7) may be identical or different from each other, and is selected from halogens and alkyl fluorides. R^{1c} and R^{2c} may from a cyclic structure wherein they are bonded together. Specific examples thereof include LiN(FSO₂)₂, LiN(CF₃SO₂)₂, LiN(C₂F₅SO₂)₂, LiN(CF₃SO₂)(C₄F₉SO₂), CTFSI-L1 (LiN(SO₂CF₂)₂) which is a five-membered cyclic compound, and LiN(SO₂CF₂)₂CF₂ which is a six-membered cyclic compound.

In addition, as the lithium salt, a compound represented by the following general formula (8) can be cited.

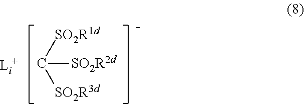

R^{1d}, R^{2d} and R^{3d} in the general formula (7) may be identical or different from each other, and is selected from halogens and alkyl fluorides. Concrete examples thereof include LiC(CF₃SO₂)₃ and LiC(C₂F₅SO₂)₃. These lithium salts may be used alone or in combination of two or more. Among the lithium salts, LiN(CF₃SO₂)₂ and LiN(C₂F₅SO₂) having high heat stability, and LiN(FSO₂)₂ and LiPF₆ having high ionic conductance are particularly preferable.

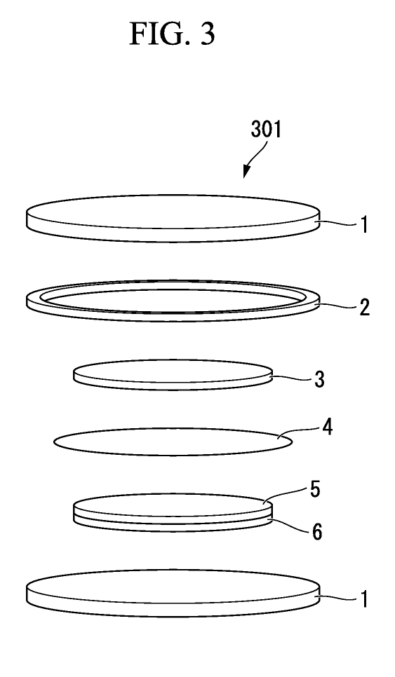

The secondary battery 201 may be provided with a separator (refer to FIG. 3) between the positive electrode 202 and the negative electrode 203 in order to prevent the contact of the positive electrode 202 and the negative electrode 203. The separator can be selected optionally, and a nonwoven fabric, a cellulose film and a porous film made of polyethylene, polypropylene or the like can be used. The separator may be used alone or in combination of two or more.

The shape of the secondary battery is not limited particularly, and any conventionally known shapes can be used. The shape of the secondary battery may be, for example, a circular cylindrical shape, a rectangular shape, a coin-like shape or a sheet-like shape. The secondary battery having such a shape is obtained by sealing a combination of the aforementioned positive electrode, the negative electrode, the electrolyte solution and the separator, or sealing an layered body thereof or wound body thereof, with a metal case, a resin case, or a laminated film consisting of a synthetic resin film and a metal foil such as aluminum foil.

(Production Method of a Secondary Battery)

Hereinafter, preferable examples of a production method of a secondary battery according to the present invention are explained below.

At first, a method of forming an electrolyte solution is explained. The electrolyte solution is prepared in a dry room by dissolving a carbonate compound in a solution wherein a lithium salt has been dissolved at a certain concentration.

Next, the method of forming a positive electrode is explained.

VGCF (trade name, Carbon nano-fiber) made by Showa Denko K.K. is mixed as a conductive agent with a lithium-manganese composite oxide (LiMn₂O₄) material as a positive electrode active material, and the mixture obtained is dispersed in N-methylpyrolidone (NMP) to produce slurry. Then, the slurry is applied on an aluminum foil serving as a positive electrode collector and dried to generate a positive electrode having a diameter of 12 mmφ (hereinafter, referred as a LiMn₂O₄ positive electrode). Next, the electrolyte solution to which lithium salt has been dissolved, a lithium metal electrode, and the aforementioned LiMn₂O₄ positive electrode, and an electrically conductive material are prepared. The concentration of lithium salt included in the electrolyte solution can be selected optionally, but 0.1 to 3 is preferable, and 0.8 to 2 is more preferable. The kind of lithium salt can be selected optionally, and for example, LiP6, LiTFSI, LiBETI and the like is preferably used. Then, under the condition that the LiMn₂O₄ positive electrode and the lithium metal are combined with the electrically conductive material (that is, in the condition that they are combined electrically), they are immersed in the electrolyte solution to which lithium salt has been dissolved. That is, the lithium metal electrode and the LiMn₂O₄ positive electrode are shorted in the electrolyte solution to generate an excess lithium-positive electrode. The excess amount of lithium in the positive electrode can be controlled du to the time of short. Although the period wherein of short-circuit is performed can be selected optionally, for example, 1 to 60 minutes are preferable.

As the result of the short-circuit, lithium ions are selectively adhered to the surface portion of the positive electrode. Then, the amount of lithium existing at the surface of the positive electrode is relatively larger than that of existing at the interior of the positive electrode. That is, as the film in which the amount of lithium is relatively large is formed at the surface of the positive electrode, the formed film functions as a protective film, and the volume change caused due to the change of crystal structure becomes hard to be caused. Accordingly, deterioration of cycle performance which has been conventionally caused due to the volume change can be prevented. Furthermore, due to the protective film formed on the surface of the positive electrode, decomposition reaction which has conventionally caused on the positive electrode becomes hard to be caused, and impurity becomes hard to be generated.

Here, as an electrolysis solution, a carbonate-based electrolysis solution can preferably used. When the penetration of an electrolysis solution to an electrode is considered, it is preferable that the electrolysis solution used in the step be the same as an electrolysis solution which is used in a secondary battery, which is obtained after the generation of the excess lithium-positive electrode and includes the excess lithium-positive electrode. Furthermore, similar to this reason, it is preferable that a lithium salt used in the step be the same as that used in a secondary battery which includes the excess lithium-positive electrode. As the lithium metal electrode, lithium electrode which is made of lithium metal alone, a lithium electrode which is deposited on a copper foil in order to improve electro conductivity or the like can be used. The electrically conductive material is not limited in particular in so far as it is a material which easily carries electricity, and for example, a copper wire, an aluminum bar or the like can be used. The electrically conductive material serves as a material which combines a lithium metal electrode and a lithium transition oxide electrode, and flows electric current.

Subsequently, the method of manufacturing a negative electrode is explained below. A graphite material used as a negative electrode active material is dispersed in N-methylpyrolidone (NMP) to produce slurry, and the slurry is applied on a copper foil used as a negative electrode collector and dried to produce a negative electrode having a diameter of 12 mmφ. In the present invention, it is preferable that a film be formed on the surface of a negative electrode in advance (hereinafter, referred as a negative electrode with SEI).

As an example of the method of manufacturing a negative electrode with SEI, a method can be cited wherein a coin cell, which consists of a negative electrode, a lithium metal, which exists as a counter electrode via a separator, and an electrolyte solution, was manufactured, and a film is formed electrochemically on the surface of the negative electrode by repeating 10 cycles of discharge and charge in this order at a rate of 0.1 C. As the electrolyte solution used in the method, a solution can be used which is prepared by dissolving lithium hexafluorophosphate (LiPF₆, molecular weight: 151.9) at a concentration 1 mol/L in a carbonate organic solvent. As the carbonate organic solvent, a liquid mixture of ethylene carbonate (EC) and diethyl carbonate (DEC) which are mixed in a volume ratio of 30:70 (hereafter, described as EC/DEC (30:70)) can be used. The cut-off potential in the method is set to 0 V when discharge is performed and set to 1.5 V when charge is performed. After the 10th charge, the coin cell is deconstructed to take out an electrode consisting of graphite (negative electrode with SEI), and the electrode is used as a negative electrode of the present invention.

Next, an example of manufacturing a coin-type secondary battery 301 is explained. FIG. 3 is an exploded view of a coin-type secondary battery. As shown in FIG. 3, at first, a positive electrode 5 which is obtained by the aforementioned method is provided on a positive electrode collector 6 made of stainless steel and serving also as a coin cell receptacle, and a negative electrode 3 of graphite is further provided thereon via a separator 4 which is a porous polyethylene film, whereby an electrode layered body is obtained. Subsequently, an electrolyte solution obtained by the aforementioned method is supplied to the electrode layered body to perform vacuum impregnating so that air spaces of the electrodes 3 and 5 and the separator 4 are impregnated. Then, an insulation gasket 2 and the negative electrode collector serving as the coin cell receptacle are laminated, and the outside of the whole body is covered with a stainless-steel outer packaging 1, and they are combined by a caulking device to obtain a coin-type secondary battery.

According to a secondary battery 201 of the present embodiment, it is possible to improve cycle performance and rate performance. The present inventors generated a secondary battery 201 wherein a positive electrode comprised a compound represented by the composition formula: LiₐM¹_{b}O_{d} or LiₐM¹_{b}M²_{c}O_{d}, and performed evaluations of cycle performance and rate performance thereof, and as the result, they found that such secondary battery can improve cycle performance and rate performance. The present inventors presume that the improvement is caused such that, when charging is performed, the amount of lithium which is stored in a negative electrode increases due the use of a positive electrode (excess lithium-positive electrode), as compared with a case that a general positive electrode is used, and subsequent discharging capacity thereof increases. Since an excess lithium-positive electrode 202 is generated by electrically combining lithium metal and a lithium-containing transition metal oxide in an electrolyte solution 204 which includes lithium ions, lithium ions selectively adhere to the surface portion of a positive electrode 202. As a result, with respect to the amount of lithium of the positive electrode 202, the amount of lithium existing at the surface portion of the positive electrode 202 becomes larger than that existing at the interior of the positive electrode 202. Namely, it is presumed that, a film having comparatively large amount of lithium is formed at the surface of the positive electrode 202, the formed film functions as a protective film, and volume changes which are caused by crystal-structure change become hard to be caused at the positive electrode 202. Therefore deterioration of cycle performance originated from volume change, which is conventionally caused, can be prevented. Furthermore, a decomposition reaction which has conventionally caused on the positive electrode becomes hard to be caused due to the protective film formed at the surface of the positive electrode 202, and impurity becomes hard to be generated. Therefore, adverse effects to battery reaction, which is a conventional concern, can be prevented.

According to the above structure, the electrolyte solution 204 includes 15% by volume or more of phosphate ester, it is possible to make the electrolyte solution 204 non-flammable. Accordingly, it is possible to generate a secondary battery which has high safety.

According to the above structure, the electrolyte solution 204 can include a carbonate organic solvent and therefore capacity can be increased. Accordingly, it is possible to supply a secondary battery 201 which is excellent in cycle performance and rate performance.

According to the above structure, the electrolyte solution 204 can include a film-forming additive which forms a film to the surface of the negative electrode 203.

Furthermore, a film can be formed in advance on the negative electrode 203,

wherein the film is impermeable to an electrolyte solution 204 but permeable to lithium ions. Since a film (SEI) which is formed to the surface of the negative electrode 203 functions as a protective film, reductive decomposition of a negative electrode 203 and an electrolyte solution 204 can be inhibited. A reaction at the negative electrode 203 can be occurred reversibly and smoothly. Therefore, capacity degradation of the secondary battery 201 can be prevented. Accordingly, a secondary battery 201 which can maintain excellent cycle performance and rate performance can be provided.

### EXAMPLES

The inventors performed experiments which demonstrated the effects of a secondary battery of the present invention. Concretely, a secondary battery described above was manufactured. In the manufacturing steps thereof, period of short-circuit was set to the predetermined short-circuit duration, the amount of lithium included in the positive electrode is set to the predetermined amount, and a mixing ratio of a phosphorus compound, a carbonate organic solvent, a film-forming additive and lithium, which are dissolved in the electrolyte solution was set to the predetermined condition. It was demonstrate that, by combing these conditions, it is possible to improve cycle performance and rate performance.

Hereinafter, experimental results are explained.

(Measurement of XRD)

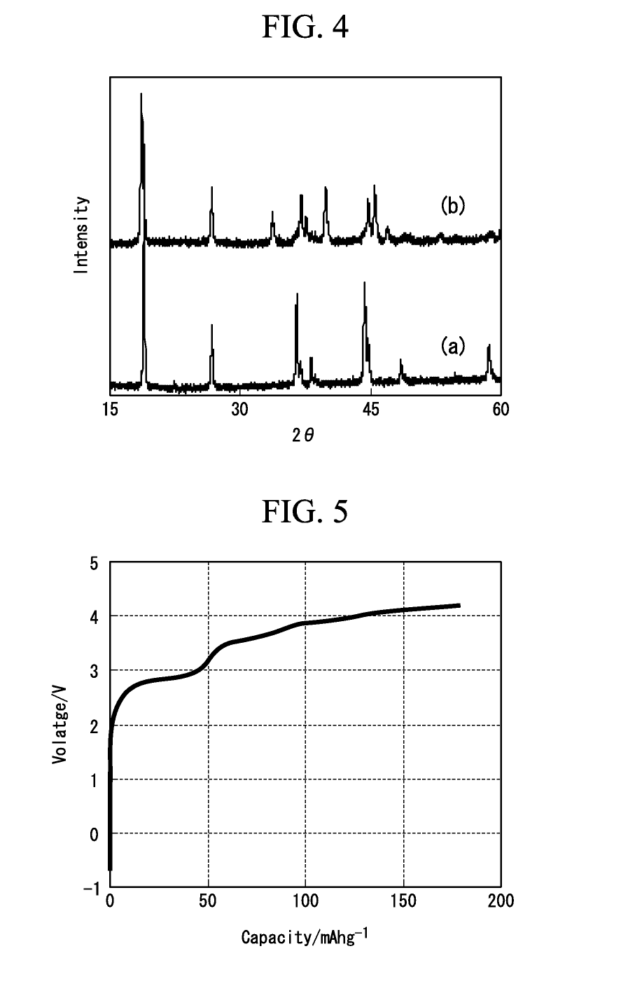

Conditions of measuring XRD were performed in the range of: diffraction angle 2θ=15 to 60° using X-ray (CuKα=1.5406 Å, Generator Voltage=45 kV, Tube Current=40 mA). As the manufacturing conditions of an excess lithium positive electrode, an electrolyte, wherein LiPF₆ salt was dissolved at a concentration of 1.0 mol/L in a mixed solution of EC:DEC (30:70), a lithium metal electrode, a LiMn₂O₄ positive electrode, and a stainless foil as an electrically conductive material were used. The short-circuit duration was set to 15 minutes. XRD evaluation results of a coin-type cell, wherein a LiMn₂O₄ positive electrode to which short-circuit was performed with lithium metal for 15 minutes was used, and a LiMn₂O₄ positive electrode (positive electrodes used in Comparative Examples 1 to 5) are shown in FIG. 4.

(Evaluation of a Plateau Region)

Evaluation was performed with FIG. 5 which shows an initial charge curve of a coin cell including a LiMn₂O₄ positive electrode, which was obtained by short-circuit performed for fifteen minutes with lithium metal (the coin cell is the same as those used in Examples 1 to 8).

(Evaluation of Flammability Test)

The flammability test and evaluations thereof were performed based on the following standard wherein a strip of glass fiber filter paper to which an electrolyte solution was immersed was brought close to a flame, and the filter paper was moved away from the frame, and it was checked whether or not the filter paper had caught fire.

(Measurement of a Capacity Maintenance Rate)

Evaluation of a capacity maintenance rate was performed using a coin-type secondary battery generated by the method described in the following Examples. The evaluation of discharge capacity of the coin-type secondary battery was performed according the following procedures. The charge was performed at constant current and constant voltage at a rate of 0.2 C, and upper limit voltage was set to 4.2 V. Similarly, discharge was performed at a rate of 0.2 C and cut-off voltage was set to 3.0 V. A discharge capacity observed in the process was determined as an initial discharge capacity. A rate of discharge capacity after 10 cycles to an initial discharge capacity was set as a capacity maintenance rate. Discharge capacity is a value per unit mass of a positive active material. The evaluation results of the capacity maintenance rate are shown in Table 1 (Examples 1 to 8, and Comparative Examples 1 to 5)

(Measurement of Rate performance)

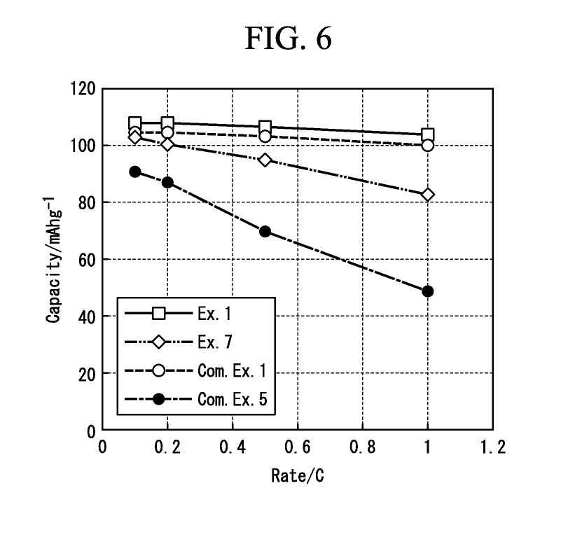

After the evaluation of the aforementioned capacity maintenance rate, the evaluation of rate performance was performed for the electrodes used. At first, charge was performed at the constant current and constant voltage to the upper limit voltage of 4.2 V at a rate of 0.2 C, and then, discharge was performed at a constant current in a rate of 1.0C, 0.5C, 0.2 C and 0.1 C in this order. The lower limit of voltage was set at 3.0 V. The discharge capacity in each rate is determined as a total value which is obtained by adding the discharge capacity obtained in each rate to the discharge capacity which has been obtained before said rate. The results of the rate performance evaluation with respect to Examples 1 and 7 and Comparative Examples 1 and 5 are shown in FIG. 6.

### Example 1

7 g of VGCF (trade name, a carbon nano-fiber) made by Showa Denko K.K., which was used as a conductive agent, was mixed with 85 g of a lithium-manganese composite oxide (LiMn₂O₄), and then the mixture was dispersed in N-methylpyrolidone (NMP) to produce slurry. Then, the slurry was applied on an aluminum foil used as a positive electrode collector so that the thickness of a dried film of the sulurry is 160 μm, and dried to generate a positive electrode having a diameter of 12 mm (hereinafter, referred as a LiMn₂O₄ positive electrode). Next, an electrolyte solution, wherein LiPF₆ salt had been dissolved at a concentration of 1.0 mol/L in a mixed solution of EC:DEC (30:70), a lithium metal electrode, the aforementioned LiMn₂O₄ positive electrode and an electrically conductive material (stainless foil) were prepared. Then, under the condition that the LiMn₂O₄ positive electrode and the lithium metal were combined with the electrically conductive material, they were immersed in the electrolyte solution to which lithium salt had been dissolved, and shot-circuit was performed in the electrolyte between the LiMn₂O₄ positive electrode and the lithium metal electrode for 15 minutes to form an excess lithium-positive electrode.

90% by mass of a graphite material used as a negative electrode active material was mixed with 8% by mass of polyvinylidene fluoride as a binder, and N-methylpyrolidone (NMP) was further added to the mixture so that the mixture was dispersed to produce slurry. Then, the slurry was applied on a copper foil used as a negative electrode collector so that the thickness of a dried film of the sulurry is 120 um, and dried to generate a negative electrode having a diameter of 12 mm.

Then, a coin cell, which consisted of the negative electrode, a lithium metal, which functioned as a counter electrode via a separator, and an electrolyte solution, was manufactured. Then, 10 cycles of discharge and charge were repeated for the cell in this order at a rate of 0.1 C, and a film was electrochemically formed on the surface of the negative electrode. The electrolyte solution used in the step was a solution which was prepared by dissolving lithium hexafluorophosphate (LiPF₆, molecular weight: 151.9) at a concentration 1 mol/L in a carbonate organic solvent. As the carbonate organic solvent, a mixed liquid of ethylene carbonate (EC) and diethyl carbonate (DEC) which were mixed in a volume ratio of 30:70 was used. The cut-off potential in the step was set to 0 V when discharge was performed, and set to 1.5 V when charge was performed. After the 10th charge, the coin cell was deconstructed to take out an electrode consisting of graphite (negative electrode with SEI), and the electrode was used as a negative electrode in Example 1.

The LiMn₂O₄ positive electrode (excess lithium-positive electrode) which was obtained by the 15 minute short-circuit with the lithium metal, the aforementioned negative electrode made of a graphite material, the electrolyte solution wherein 2% by volume of VC was added to the carbonate organic solvent EC:DEC (30:70) in which LiPF₆ salt have been dissolve at a concentration of 1.0 mol/L, were used to form a coin cell. As a separator, a porous polyethylene film was used. The evaluations of the coin cell were performed, and the results thereof are shown in Table 1.

### Example 2

Productions and evaluations were performed similar to that of Example 1, except that concentration of LiPF₆ was changed from 1.0 mol/L to 2.0 mol/L, and the results thereof are shown in Table 1.

### Example 3

Productions and evaluations were performed similar to that of Example 2, except that a solution (EC:DEC:TMP=23:52:25) was used which was prepared by mixing EC:DEC (30:70) and trimethyl phosphate (TMP) at a volume rate of 75:25, and the results thereof are shown in Table 1.

### Example 4

Productions and evaluations were performed similar to that of Example 3, except that the short-circuit duration was changed from 15 minutes to 10 minutes, and lithium(tetrafluorosulfonyl)imide (LiTFSI, molecular weight is 287.1) as a LiTFSI salt was dissolved in the electrolyte solution instead of LiPF₆ salt. The results are shown in Table 1.

### Example 5

Productions and evaluations were performed similar to that of Example 3, except that a solution (γBL:TMP=60:40) wherein γ-butyrolactone (γBL) and TMP were mixed at the volume ratio of 60:40 was used instead of the solution (EC:DEC:TMP=23:52:25) wherein EC:DEC (30:70) and trimethyl phosphate (TMP) were mixed at a volume rate of 75:25. The results are shown in Table 1.

### Example 6

Productions and evaluations were performed similar to Example 4, except that a solution (γBL:TMP=60:40) wherein γ-butyrolactone (γBL) and TMP were mixed at the volume ratio of 60:40 was used instead of the solution (EC:DEC:TMP=23:52:25) wherein EC:DEC (30:70) and trimethyl phosphate (TMP) were mixed at a volume rate of 75:25. The results are shown in Table 1.

### Example 7

Productions and evaluations were performed similar to Example 6, except that a concentration of LiPF₆ was changed from 2.0 mol/L to 2.5 mol/L, and the results thereof are shown in Table 1.

### Example 8

Productions and evaluations were performed similar to Example 3, except that a solution (EC:DEC:TMP=18:42:40) which was prepared by mixing EC:DEC (30:70) and trimethyl phosphate (TMP) at a volume rate of 60:40 was used in stead of a solution (EC:DEC:TMP=23:52:25) which was prepared by mixing EC:DEC (30:70) and trimethyl phosphate (TMP) at a volume rate of 75:25, and a negative electrode with SEI was used on which a film had been electrically formed on the surface thereof. The obtained results thereof are shown in Table 1.

### Comparative Example 1

A coin cell was formed with a LiMn₂O₄ positive electrode, a negative electrode made of a graphite material, an electrolyte solution wherein 2% by volume of VC was added to the carbonate organic solvent EC:DEC (30:70) in which LiPF₆ salt have been dissolve at a concentration of 1.0 mol/L. The obtained results thereof are shown in Table 1.

### Comparative Example 2

Productions and evaluations were performed similar to Comparative Example 1, except that concentration of LiPF₆ was changed from 1.0 mol/L to 2.0 mol/L. The obtained results thereof are shown in Table 1.

### Comparative Example 3

Productions and evaluations were performed similar to Comparative Example 2, except that a solution (EC:DEC:TMP=23:52:25) was used which was prepared by mixing EC:DEC (30:70) and trimethyl phosphate (TMP) at a volume rate of 75:25, and VC was not added thereto. The obtained results thereof are shown in Table 1.

### Comparative Example 4

Productions and evaluations were performed similar to Comparative Example 3, except that a solution (γBL:TMP=60:40) wherein γ-butyrolactone (γBL) and TMP were mixed at the volume ratio of 60:40 was used instead of the solution (EC:DEC:TMP=23:52:25) wherein EC:DEC (30:70) and trimethyl phosphate (TMP) were mixed at a volume rate of 75:25. The obtained results thereof are shown in Table 1.

### Comparative Example 5

Productions and evaluations were performed similar to Comparative Example 4, except that lithium(tetrafluorosulfonyl)imide (LiTFSI, molecular weight is 287.1) as a LiTFSI salt was dissolved at a concentration of 2.5 mol/L in the electrolyte solution instead of LiPF₆ salt. The results are shown in Table 1.

TABLE 1

| | Carbonate | Phosphate ester | Composition ratio | | | | | | Capacity |
|---|---|---|---|---|---|---|---|---|---|
| | organic solvent | derivative | (Volume ratio) | | Lithium | Concentration | | Short-circuit | maintenance |
| | X | Y | X | Y | salt | (mol/L) | Additive | duration | rate (%) |
| Ex. 1 | EC:DEC (30:70) | | 100 | | LiPF6 | 1.0 | VC | 15 min. | 99.3 |
| Ex. 2 | EC:DEC (30:70) | | 100 | | LiPF6 | 2.0 | VC | 15 min. | 99.6 |
| Ex. 3 | EC:DEC (30:70) | TMP | 75 | 25 | LiPF6 | 2.0 | VC | 15 min. | 99.1 |
| Ex. 4 | EC:DEC (30:70) | TMP | 75 | 25 | LiTFSi | 2.0 | VC | 10 min. | 99.5 |
| Ex. 5 | γBL | TMP | 60 | 40 | LiPF6 | 2.0 | VC | 15 min. | 98.7 |
| Ex. 6 | γBL | TMP | 60 | 40 | LiTFSi | 2.0 | VC | 10 min. | 98.5 |
| Ex. 7 | γBL | TMP | 60 | 40 | LiTFSi | 2.5 | VC | 10 min. | 99.7 |
| Ex. 8 | EC:DEC (30:70) | TMP | 60 | 40 | LiPF6 | 2.0 | VC | 15 min. | 99.8 |
| Com. Ex. 1 | EC:DEC (30:70) | | 100 | | LiPF6 | 1.0 | VC | | 98.8 |
| Com. Ex. 2 | EC:DEC (30:70) | | 100 | | LiPF6 | 2.0 | VC | | 99.2 |
| Com. Ex. 3 | EC:DEC (30:70) | TMP | 75 | 25 | LiPF6 | 2.0 | | | 69.8 |
| Com. Ex. 4 | γBL | TMP | 60 | 40 | LiPF6 | 2.0 | | | 52.1 |
| Com. Ex. 5 | γBL | TMP | 60 | 40 | LiTFSi | 2.5 | | | 53.9 |

(Evaluations of XRD)

FIG. 4 is a view which shows the measurement results of XRD of the positive electrodes of Examples and Comparative Examples. In FIG. 4, the horizontal axis represents angle of diffraction (20), and the vertical axis represents intensity. Furthermore, the sign (a) shows a XRD pattern of Comparative Examples (LiMn₂O₄ positive electrode), and the sign (b) shows a XRD pattern of Examples (LiMn₂O₄ positive electrode to which short-circuit was performed for 15 minutes with lithium metal). As shown in FIG. 4, XRD pattern (b) of Examples has a peak position which is different from that of XRD pattern (a) of Comparative Examples, and was confirmed that the structure change was occurred. It was confirmed that, as the result of the reaction represented by LiMn₂O₄+ye⁻+yLi⁺→Li_{1+y}Mn₂O₄ (0<y≦1), that is, as the result of doping of lithium to a LiMn₂O₄ positive electrode, which was caused by the short-circuit of the LiMn₂O₄ positive electrode and lithium metal performed in the electrolyte solution at the predetermined duration, a reaction wherein a crystal structure was change from cubic to tetragonal was occurred.

(Evaluation of a Plateau Region)

FIG. 5 shows an initial charge curve of coin cells of Examples (coin cell having a LiMn₂O₄ positive electrode which was obtained by performing short-circuit with lithium metal for 15 minutes). In FIG. 5, the horizontal axis represents capacity, and the vertical axis represents voltage. From the XRD pattern of FIG. 4, it was confirmed that the LiMn₂O₄ positive electrode, to which short-circuit was performed for 15 minutes with lithium metal, had excess doped lithium in the LiMn₂O₄ positive electrode according the reaction represented by LiMn₂O₄+ye⁻+yLi⁺→Li_{1+y}Mn₂O₄ (0<y≦1). From FIG. 5, it was confirmed that a plateau region existed at the voltage of 2.8 to 3.0 V when coin cells of Examples were used. The plateau region existing at the voltage of 2.8 to 3.0 V is originated from a reaction (Li_{1+y}Mn₂O₄→LiMn₂O₄+ye⁻+yLi⁺ (0<y≦1)) in which the LiMn₂O₄ positive electrode, to which lithium was doped excessively, goes back to the original structure.

(Evaluation of Flammability Test)

As the result of an evaluation test of flammability, it was confirmed that, due to the addition of TMP to a electrolyte solution which included EC:DEC (30:70) or γBL, the electrolyte solution had flame retardance. That is, with respect to the electrolyte solutions used in Examples, it was confirmed that electrolyte solutions which included 25% by volume or more of TMP had flame retardance, as, when strips of glass fiber filter papers to which the electrolyte solutions were immersed were brought close to a flame and were moved away from the frame, the filter papers had not caught fire. Other electrolyte solutions such as Examples 1 and 2 and Comparative Examples 1 and 2, which does not include TMP, were confirmed that they caught fire when strips brought close to a flame and were moved away from the frame. That is, the electrolytes had flammability.

(Evaluation of a Capacity Maintenance Rate)

Table 1 shows the evaluation results of the capacity maintenance rate of Examples 1 to 8 and Comparative Examples 1 to 5. As shown in Table 1, it was confirmed that all electrolyte solutions which contained EC:DEC (30:70) showed capacity maintenance rates which were nearly 99% except for Comparative Example 3, and therefore it was confirmed that excellent cycle performance was achieved (refer to Comparative Examples 1, 2 and the like). Furthermore, it was confirmed that a capacity maintenance rate further increased due to the use of an excess lithium-positive electrode (refer to comparison between Examples 1 and 2 and Comparative Examples 1 and 2). The phenomenon was observed outstandingly when electrolyte solutions were used to which trimethyl phosphate (TMP) was mixed, and therefore it was confirmed that a capacity maintenance rate of the cases where general positive electrodes were used was about 50 to 70% (referred to Comparative Examples 3 to 5), and a capacity maintenance rate of the cases where excess lithium-positive electrodes were used exceeded 98% (referred to Examples 3 to 7). In this way, it was confirmed that cycle performance was able to increase due to the use of the excess lithium-positive electrode. Although deterioration of cycle performance was conventionally observed when phosphate ester was mixed to an electrolyte solution to achieve flame resistance, it was confirmed that cycle performance was dramatically improved in the present invention due to the use of an excess lithium-positive electrode while flame retardance was maintained. Accordingly, a lithium ion secondary battery which includes an electrolyte solution to which a flame retardant treatment has been performed to increase safety can be normally operated when coin cells of Examples are used.

Here, in the secondary battery of the Examples, it is preferable that the lower potential at the time of discharge be 3.0 V. When the lower potential is set lower than 3.0 V, cycle performance deteriorate due to the reaction represented by LiMn₂O₄+ye⁻+yLi⁺→Li_{1+y}Mn₂O₄ (0<y≦1). Although it may be possible to decrease the lower potential to the value which does not cause the aforementioned reaction, 3.0 V is desirable. When the above reaction is not caused, it is possible to decrease the lower potential at the time of discharge to 2.85 V. That is, merely in the initial discharge, the reaction: Li_{1+y}Mn₂O₄LiMn₂O₄+ye⁻+yLi⁺(0<y≦1) may be caused. When it is represented by the general formulae, reaction LiₐM¹_{b}O_{d→}LiM¹_{b}O_{d}+ye⁻+yLi⁺ or LiₐM¹_{b}M²_{c}O_{d→}LoM¹_{b}M²_{c}O_{d}+ye⁻+yLi⁺ (0<y≦1) is caused merely in the initial discharge. In the formula, a, b, c and d represent numbers in ranges of: 1.2≦a≦2, 0<b, c≦2, and 2≦d≦4. In the formula, M¹ and M² represent any one kind of elements selected from the group consisting of Co, Ni, Mn, Fe, Al, Sn, Mg, Ge, Si and P, and M¹ and M² are not identical, and M¹ and M² are different from each other. In the above formula, 1+y is represented by a. The upper potential can be selected optionally. Although 5.0 V or less is preferable for a high potential electrode such as Li_{1+y}Ni_{0.5}Mn_{1.5}O₄, 4.3 V is preferable in general, and 4.2 V or less or more is preferable.

(Evaluation of Rate performance)

FIG. 6 is a figure which shows evaluation results of rate performance of coin cells of Examples and Comparative Examples. In FIG. 6, the horizontal axis represents a rate, and the vertical axis represents capacity. As shown in FIG. 6, it was conformed that rate performance was improved due to the use of an excess lithium-positive electrode (refer to Examples 1 and 7, and Comparative Examples 1 and 5). It is presumed that such results were obtained due to the use of the excess lithium-positive electrode, since the amount of lithium which was stored in the negative electrode when charging was performed increased and therefore subsequent discharging capacity also increased as compared with a case that a general positive electrode was used.

Accordingly, it was confirmed that cycle performance and rate performance can be improved when a positive electrode which is represented by the composition formula LiₐM¹_{b}O_{d} or LiₐM¹_{b}M²_{c}O_{d} (a, b, c and d, which represent a composition ratio of the above composition formulae, represent numbers in ranges of: 1.2≦a≦2, 0<b, c≦2, and 2≦d≦4, and M¹ and M² in the above formulae represent any one kind of elements selected from the group consisting of Co, Ni, Mn, Fe, Al, Sn, Mg, Ge, Si and P, and M¹ and M² are different from each other) is used for a secondary battery.

Although plateau regions were observed in the voltage of 2.8 to 3.0 V at the initial charge (refer to FIG. 5) when coin cells of Examples were used, no structure change was caused after the initial discharge since the lower limit of potential at the time of discharge was 3.0 V. That is, change of cycle performance accompanied by the structural change was not caused.

Furthermore, the excess lithium-positive electrodes of the Examples are positive electrodes represented by the composition formula: LiₐM¹_{b}O_{d} or LiₐM¹ⁱ_{b}M²_{c}O_{d}, and a which represents a composition ratio is 1.2≦a≦2 at an atomic ratio. Irreversible capacity becomes too large in the initial charge and discharge, when the value of a is too large. Accordingly, it is preferable to satisfy a≦1.7, and more preferably a≦1.5. Furthermore, when the value of a is less than 1.2, the structural change is not caused at the initial charge, and therefore it is necessary to satisfy 1.2≦a.

Furthermore, in the Examples, 15% by volume or more of phosphate ester was mixed to the electrolyte solution so that they had flame retardance. Although phosphate ester can be added to the electrolyte solution optionally, the ratio of phosphate ester added to the electrolyte solution is preferably 20% by volume or more, and more preferably 25% by volume or more. Furthermore, in order to prevent the decomposition of phosphate ester, the concentration of lithium included in the electrolyte solution need to be 1.0 mol or more, the concentration of lithium is more preferably 1.2 mol or more, and more preferably 1.5 mol or more. In general, ionic conductance in an electrolyte solution decreases when concentration of lithium salt is high, and therefore rate performance deteriorates. However, it was confirmed that rate performance is remarkably improved due to the use of an excess lithium-positive electrode of the present invention (refer to FIG. 6).

### INDUSTRIAL APPLICABILITY

The present invention can provide a secondary battery which can increase cycle performance and rate performance.

### BRIEF DESCRIPTION OF THE REFERENCE SIGNS

3: positive electrode
5: negative electrode
102: lithium transition metal oxide electrode (lithium-containing transition metal oxide)
103: lithium electrode (lithium metal)
104: electrolyte solution (second electrolyte solution)
201: secondary battery
202: positive electrode
203: negative electrode
204: electrolyte solution (first electrolyte solution)
301: coin type secondary battery

1. A secondary battery including:
a positive electrode which comprises an oxide which absorbs and releases lithium ions;
a negative electrode which comprises a material which absorbs and releases the lithium ions; and
a first electrolyte solution which transports charge carriers between the positive electrode and the negative electrode; wherein
the positive electrode comprises a compound, which is represented by the composition formula: LiₐM¹_{b}O_{d} or LiₐM¹_{b}M²_{c}O_{d}, and
the positive electrode is formed by electrically combining lithium metal and a lithium-containing transition metal oxide in a second electrolyte solution which includes lithium ions,
(a, b, c and d, which represent a composition ratio of the above composition formulae, are numbers in ranges of: 1.2≦a≦2, 0<b, c≦2, and 2≦d≦4; and M¹ and M² in the above formulae represent any one kind of elements selected from the group consisting of Co, Ni, Mn, Fe, Al, Sn, Mg, Ge, Si and P, and M¹ and M² are different from each other).

2. The secondary battery according to claim 1, wherein the first electrolyte solution comprises 15% by volume or more of a phosphate ester.

3. The secondary battery according to claim 1, wherein the first electrolyte solution comprises a carbonate organic solvent.

4. The secondary battery according to claim 1, wherein the first electrolyte solution includes a film-forming additive, which forms a film electrochemically on the negative electrode.

5. The secondary battery according to claim 1, wherein a film has been formed on the negative electrode, and the film is impermeable to the first electrolyte solution but permeable to lithium ions.

6. The secondary battery according to claim 1, wherein the positive electrode is an excess lithium-positive electrode wherein the lithium content of the electrode is larger than that of lithium-containing transition metal oxide, and the amount of lithium existing at the surface portion of the positive electrode is larger than that existing at the interior of the positive electrode.

7. The secondary battery according to claim 1, wherein the positive electrode has a film formed to the surface of the positive electrode, and the film has the lithium content which is larger than that of interior of the positive electrode.

8. The secondary battery according to claim 1, wherein the first electrolyte solution and the second electrolyte solution are solutions to which lithium salt has been dissolved, and the solutions include the same lithium salt.
